(19) United States
(12) Patent Application Publication
(10) Pub. No.: US 2025/0052661 A1
(43) Pub. Date: Feb. 13, 2025

(54) Method to determine precisely the size of small particles via vapor condensation

(71) Applicant: Juan Fernandez de la Mora, New Haven, CT (US)

(72) Inventor: Juan Fernandez de la Mora, New Haven, CT (US)

(21) Appl. No.: 18/445,430

(22) Filed: Aug. 8, 2023

(51) Int. Cl. G01N 15/06

(52) U.S. Cl. CPC G01N 15/065; G01N 2015/0687; G01N 15/075

(57) ABSTRACT

Improvement are proposed to increase the size accuracy and resolving power with which variants of the variable saturation condensation particle sizer (VSCPS) of Gallar et al. (2006) may characterize particles suspended in a gas. One essential component of this invention is an efficient method to achieve saturation of the gas flow passing through a saturation chamber, independently from the value of the gas flow rate through that chamber. The resulting strict linearity between the maximum vapor saturation ratio achieved in the instrument and the finely controlled gas flow rate through the saturator facilitates the precise inference of particle size, as well as the possibility to determine size without lengthy calibrations. Also described is a novel approach to introduce the particles to be sized in the center of a stream of vapor laden sheath gas. The new sheathing method delays the flow instability in prior sheathing schemes, where the aerosol was injected from a centered capillary into the surrounding sheath gas/vapor mixture. In one embodiment of this invention, the centered aerosol flow is fed at the bottom of a cylindrical tube, while the gas/vapor mixture enters laterally through the porous walls of this tube. This mixing approach is intrinsically stable over a much wider range of flow rates of sheath and aerosol, allowing for improvements in sizing resolution. In another embodiment the flow in the mixing region is stabilized by accelerating the gas either in the missing region or after it. A method to infer a condensation size without the need of extensive calibration or complex numerical computations is also disclosed.

### CROSS-REFERENCE TO RELATED APPLICATIONS

### Patents Cited

US20080083274A1 March 2004 Hering
U.S. Pat. No. 4,790,650 A December 1988 Keady

### Other Publications

Attoui, M.; L. J. Perez-Lorenzo, C. A. Brock, J. Fernandez de la Mora, High resolution characterization of a sheathed axisymmetric Variable Supersaturation Condensation Particle Sizer, J. Aerosol Sci. 169 (2023) 106112
Fernandez de la Mora, J.; Heterogeneous nucleation with finite activation energy and perfect wetting: Capillary theory versus experiments with nanometer particles, and extrapolations on the smallest detectable nucleus, Aerosol Science and Technology, 45 (4), 543-554, 2011
Fernandez de la Mora, J. (2020) Viability of basic heterogeneous nucleation studies with thermally diffusive condensation particle counters, J. Colloid & Interphase Sci., 578814-824.
Fletcher, N. H. (1958). Size Effect in Heterogeneous Nucleation, J. Chem. Phys. 29 (3): 572-576.
Fletcher, N. (1962). The Physics of Rainclouds. Cambridge University Press, chapter 3.
Gallar, C.; C. A. Brock, J. L. Jimenez, C. Simons (2006) A Variable Supersaturation Condensation Particle Sizer, Aerosol Sci. & Techn. 40 (6) 431-436
McDermott, W. T.; R. C. Ockovic, M. R. Stolzenburg (1991) Counting Efficiency of an Improved 30-Å Condensation Nucleus Counter, Aerosol Sci. & Techn. 14 (2) 278-287.
Rao, N.; J. Navascués and J. Fernández de la Mora, (1993) Aerodynamic focusing of particles in viscous jets, J. Aerosol Sci., 24, 879-892
Rao, N.; J. Fernández de la Mora and P. McMurry (1992) High resolution aerodynamic spectrometry of submicron particles: sheathed variable-cut impactors vs. other devices; J. Aerosol Science, 23, 11-26
Stolzenburg, M. R.; P. H. McMurry, (1991) An ultrafine aerosol condensation nucleus, counter, Aerosol Sci. Techn. 14 (1), 48-65.
Wilson, J. C.; E. D. Blackshear, J. H. Hyun (1983) An improved continuous-flow condensation nucleus counter for use in the stratosphere, J. Aerosol Sci. 14 (3) 387-391.
Wiedensohler, A., Aalto, P., Covert, D., Heintzenberg, J., & McMurry, P. H. (1994). Intercomparison of four methods to determine size distributions of low concentration (100/cm³), ultrafine aerosols (3<dp<10 nm) with illustrative data from the arctic. Aerosol Science & Technology, 21 (2), 95-109.
Winkler, P. M., Steiner, G., Vrtala, A., Vehkamäki, H., Noppel, M., Lehtinen, K. E. J., Reischl, G. P., Wagner, P. E., & Kulmala, M. (2008). Heterogeneous nucleation experiments, bridging the scale from molecular ion clusters to nanoparticles. Science, 319, 1374-1377.

### STATEMENT REGARDING PRIOR DISCLOSURES BY THE INVENTOR

This application claims priority from Provisional Patent Application No. 63/374,319, filed Aug. 5, 2022; inventor: Juan Fernandez de la Mora; title: “Method to determine precisely the size of small particles via vapor condensation”

### PRIOR ART

Condensation particle counters (CPCs) have been used for over a century to detect small particles suspended in a gas by subjecting them to a saturated or supersaturated vapor. Under suitable conditions, this exposure results in the growth of the particles from initially small sizes into sizes large enough to enable their optical detection. Among many other related descriptions of CPCs, see, US parents 20080083274A1 and 4790650 A. Because this particle growth (activation) is strongly dependent on particle dimensions, CPCs have also been used to infer a size for a particle or a collection of particles. This may be done, for instance in CPCs in which the saturation ratio of the vapor is variable (Gallar et al. 2006; Wiedensohler et al. 1994).

### BACKGROUND OF THE INVENTION

The present invention relates to the determination of the size of very small particles suspended in a gas, based on the strong size dependence of the particle's ability to grow into optically detectable sizes (be activated) when immersed in a gas/vapor mixture at a saturation ratio S sufficiently above unity. The saturation ratio at a point in space is defined as the partial pressure of the vapor at that point divided by the equilibrium vapor pressure at the local temperature. Whether a particle of given size is activated or not depends very steeply on both S and some characteristic feature of the particle, which we will generically refer to as its diameter dₚ. For given dₚ, if one scans over S, the transition from undetectable to completely detectable (the activation) occurs over a narrow range of S values, whose center S′ is characteristic of this dₚ according to some measurable function S*(dₚ). This function may depend not only on particle size but also on particle shape and chemical composition. While this invention is focused on sizing particles, we should note that the improved sizing instrument to be described is closely related to widely used devices called Condensation Particle Counters (CPCs). CPCs are used as detectors for small particles, without necessarily providing size information. This invention is focused on improving the excellent design proposed by Gallar et al. (2006), whose apparatus achieves a well-defined value of S through two distinctive features. The first distinctive feature follows an earlier method introduced by Wilson et al. (1983) and perfected by Stolzenburg and McMurry (1991). In this approach, a gas stream carrying the suspended particles (the aerosol) is injected by a small capillary in the center of a larger flow of a gas/vapor stream (the sheath) confined in a cylindrical conduit. We shall refer to this method of centered aerosol injection as “capillary sheathing”. Sheathing can similarly be implemented in two-dimensional CPCs, as done in the FAST CPC commercialized by Kanomax. In what follows, we will refer to axisymmetric situations within cylindrical tubes, but this invention includes non-cylindrical axisymmetric as well as two-dimensional geometries.

The main advantage of sheathing for aerosol sizing is that the majority of the particles are exposed only the saturation ratio prevailing at the center of the sheathing stream. This S is quite uniform locally near the center, due to the symmetry (either axial or planar) of the flow. This way, most of the particles sense a unique S value at each axial position, rather than the wide range of S values present at other radial positions of the tube. The second special feature in the apparatus of Gallar et al. is a method to scan quickly and continuously over S. This is done by using a saturator containing two different volumes in a single metal block held at a given saturator temperature Tₛ. One of these volumes, termed the wet volume, contains the evaporating fluid. The other volume, termed the dry volume, contains no vapor source. By passing two independently controlled flow rates of gas Q_{w} and Q_{d} through the wet and dry volumes, and by mixing them thoroughly thereafter, a quickly variable S value is achieved on the mixture. This mixture at flow rate Q=Q_{w}+Q_{d} is then used as the sheath gas to surround an aerosol injected at a flow rate q, generally substantially smaller than Q. This combined aerosol/sheath flow is then introduced into a condenser, essentially a cold cylindrical tube whose walls are kept at a condenser temperature T_{c} lower than the saturator temperature Tₛ. Under suitable conditions, this cooling creates a saturation ratio S>1, whose value may be changed by controlling the wet fraction

$$w = {Q}_{w} / ( {Q}_{w} + {Q}_{d} ) \qquad ( 1 )$$

of the total flow going through the wet volume. An optical detector is placed downstream from the condenser, to count the particles that have grown to detectable sizes. When the aerosol contains particles of a given size, shape and composition, upon continuously increasing over S, the response from the detector is close to zero up to a certain characteristic value of S, and then rises sharply over a narrow S range, centered at a critical value S*, to a constant value corresponding to all particles having been detected. An example of this sharp response is shown in FIG. 1, representing the fraction of the particles that are activated (activation probability P) as a function of the wet fraction w defined in equation (1). In this case the particles are globules of polyethylene glycol, and the condensing vapor is n-butanol. We shall argue that the weight fraction w is directly proportional to S. The various curves shown in FIG. 1 correspond to particles of different diameters, from 3 nm (right) to 9 nm (left). The data shown in FIG. 1 were obtained with the apparatus of Gallar et al. incorporating various improvements discussed in this invention, with details provided by Attoui et al. (2023). The relation between S* and dₚ may be determined initially by calibration, and subsequently used to infer an unknown dₚ from a measured critical S. Alternatively, knowledge of the maximum value Sₘₐₓ, achieved by the saturation ratio S in the condenser, enables the determination of a characteristic theoretical quantity such as the Kelvin diameter, in which case the instrument provides a condensation size without the need of laborious calibrations.

The prior publication of Gallar et al. has demonstrated the utility of their VSCPS over a wide range of particle sizes, calibrated from about 5 nm up to 30 nm. There are, however two aspects of their instrument we wish to improve. One is that the mixing of the injected aerosol jet with the surrounding sheath flow is only stable over a limited range of the two flow rates involved. If the sheath flow Q is too large, the gas becomes unsteady or turbulent, quickly spreading the aerosol far from the center of the conduit. As a result the aerosol is not exposed to a single well defined saturation ratio, but to a wide range of S values, which greatly limits size resolution. There are also other unstable regimes when the aerosol flow q becomes large enough, due to loss of steadiness of the central jet. The instability at large Q is nevertheless the one of greater practical concern. Indeed, as long as the flow remains steady, the resolution of this instrument improves directly with Q/q, since the level of central confinement of the aerosol is controlled by this ratio. Because an excessive reduction in q is undesirable due to its negative impact on instrument sensitivity, a method to substantially increase Q without destabilizing the flow would be of great practical interest to improve size resolution.

A second set of limitations of the original VSCPS resides in the wet chamber of the saturator. The instrument of Gallar et al. used aluminum wool inside the wet volume to increase the contact area between the liquid and the gas. Even so, when tested with water vapor, the maximum S observed was well below saturation even at a rather small wet flow rate Q_{w}=0.1 l/min. S would have been even less with most other working fluids, whose vapors are typically several times less diffusive than water vapor. Ideally, the gas passing through the wet volume should achieve 100% saturation at the highest flow rate used during an S scan. For reasons to be later explained, this would enable operating the VSCPS as a linear VSCPS (LVSCPS), which has numerous inherent advantages. This maximal Q_{w} should also be in the range of 0.5 or more L/min, since Q/q ratios in the range of 10 or more are desirable for effective sheathing, while q values below 0.05 l/min are generally too small to be readily detected in typical aerosol instruments. If the wet volume provides less than 100% saturation at the maximum value of Q_{w}, the value S_{w} of S achieved at the exit of the wet volume during a saturation scan will depend on Q_{w}, and will accordingly change during the scan. It will therefore cease to be strictly linear with the precisely controllable value of w. Maintaining strict linearity to convert the VSCPS into a LVSCPS is most desirable because it makes the key quantity Sₘₐₓ strictly linear with w

$${S}_{max} = Cw \qquad ( 2 )$$

through a single constant C. Therefore, in a LVSCPS preserving this strict linearity, particle sizes may be obtained for all conditions in a scan by determining this single calibration constant. On the other hand, if this strict linearity is lost, for instance, by allowing S_{w} to fall below 100% under a certain range of Q_{w} values, then a far more laborious calibration of the device is required. Note that the strict linearity (1) hinging on achieving S_{w}=1 may also be affected by the level of liquid contained in the wet volume. An additional dependence follows from the fact that evaporative cooling of the liquid could make its temperature also dependent on the flow rate of the wet gas stream. These various circumstantial dependences make it difficult to achieve a highly repeatable condition of sheath saturation for seemingly similar settings of the instrument. The consequence is that determining the key parameter Sₘₐₓ fixing particle size, not only requires extensive calibration, but is also subject to a certain level of ambiguity. The particle size inferred is consequently also ambiguous, even after a laborious calibration. A method to achieve 100% saturation of the gas in the wet volume, independently of the value of the variable wet gas flow rate would accordingly be of great interest to determine precisely particle size. One must finally note that, in order to determine particle size with precision, it is not enough to resolve one of the two VSCPS problems noted. Both need to be solved simultaneously, because an instrument with poor resolution cannot yield the size with little ambiguity. This invention is therefore primarily addressed at alleviating these two problems.

We have stressed the interest of achieving complete vapor saturation at the exit of the wet volume, both to reduce the calibration task to the determination of a single constant C, as well as to avoid uncontrollable circumstantial variations in the calibration parameters. In past studies the determination of Sₘₐₓ has been often carried out by solving the momentum heat and mass conservation equations within the instrument. This is certainly an option to reduce the calibration effort. Even so, a single computation rather than many would suffice if strict linearity between Sₘₐₓ and w were to apply. Therefore, the interest of achieving full saturation at the exit of the wet volume remains even in cases when sufficient computation power is available to determine Sₘₐₓ accurately. Nevertheless, given the complex internal geometry of the conventional capillary sheathing approach, analytical techniques such as the Graetz method often used in simpler unsheathed CPC configurations are unreliable for the capillary geometry. A full solution of the Navier Stokes equations is then required for an accurate prediction of Sₘₐₓ in this configuration. Note furthermore that while the Navier-Stokes equations may be solved with a diversity of methods, even in complex geometries, the numerical determination of conditions under which flow instabilities arise is considerably more difficult and far less reliable than steady state calculations. An additional contribution of the present invention is that the flow calculation is greatly simplified in a new sheathing geometry to be described.

### SUMMARY OF THE INVENTION

In summary, this invention teaches methods to improve the resolution with which particle condensation size can be inferred in continuous flow CPCs of variable supersaturation, where an aerosol is introduced in the central region of a vapor-containing sheathing flow

### BRIEF DESCRIPTION OF THE DRAWINGS

FIG. 1, from Attoui et al (2023), illustrates the abrupt dependence of the signal of the optical detector as one increases the saturation of n-butanol vapor at the exit of the condenser. The various curves shown (some in duplicate form) correspond to polyethylene glycol particles of different sizes, increasing from right (3 nm) to left (9 nm).

FIG. 2 illustrates the operation of a sheathing method enabling stably joining an aerosol flow [1] entering through the left into a tube with porous walls [3], with a relatively large flow of hot vapor-carrying gas [4] penetrating inwards through the wall of the porous tube and displacing the aerosol towards the core of the tube. When the aerosol flow is cold and the diffusivity of the vapor carried by the sheath gas exceeds the thermal diffusivity of the gas carrying the aerosol, this configuration produces high vapor saturation near the tube axis without the need of the cold condenser tube [7]. When the vapor diffusivity is less than the thermal diffusivity of the gas carrying the aerosol, high vapor saturation near the tube axis is achieved thanks to the cold condenser tube [7].

FIG. 3 exemplifies a configuration where a relatively large flow of gas entering through tube [8] on the left, distributed by baffle [9] and flowing through multiple closely spaced porous surfaces [10] wetted by a liquid, is effectively saturated with the vapor from the liquid

FIG. 4 illustrates an alternative approach to stabilize the flow when an aerosol jet at flow rate q is injected through capillary tube [14] into the core of a large flow Q of vapor-carrying gas. Flow stabilization is achieved by reducing the Reynolds number in the region where both flows merge, by using relatively large diameters in both the surrounding tube [12] and the capillary tube [14], and subsequently increasing this Reynolds numbers by reducing the diameter in converging tube [11]. Alternatively, stabilization may be achieved by bringing the exit of tube [14] into the region of accelerating flow within the converging section of the conduit.

FIG. 5 illustrates a method to determine the proportionality constant C relating the maximal saturation achieved in the condenser to the wet fraction of the vapor coming from the condenser. The vertical axis represents the difference of dimensionless forms of the Kelvin diameter 1/α and the particle diameter x. The horizontal variable x is the dimensionless particle diameter. The data points use the wet fraction wₒ and particle diameter x at the midpoints of the various curves in FIG. 1, where wₒ is converted into a saturation ratio by multiplication with various assumed C values. The correct C is the one for which the data points (not joined by dotted lines) align horizontally at the larger x values, implying a constant difference between the particle diameter and the Kelvin diameter.

FIG. 6 is an alternative representation of the data of FIG. 5 in the form 1/α(x), using only the correct value of C obtained in FIG. 5. The dashed line corresponds to a constant difference between the Kelvin diameter and the particle diameter. The thin continuous curve is the prediction from capillary theory with finite activation energy and perfect wetting, whose large particle limit is the dashed straight line. The thick continuous line is the Kelvin-Thomson limit, corresponding to zero activation energy, which does not accurately represent the data.

### DETAILED DESCRIPTION OF THE INVENTION

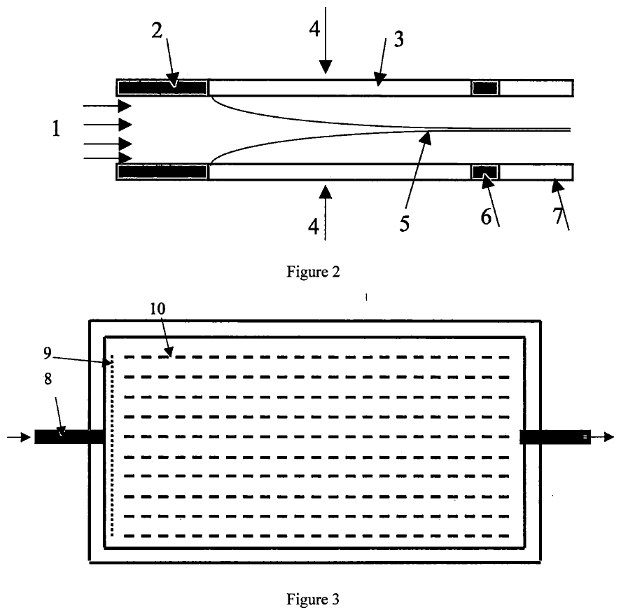

Sheathing based on a porous tube. FIG. 2 illustrates schematically the operation of a new sheathing scheme. In the embodiment shown, the aerosol enters through the left opening [1] of non-porous tube [2]. Tube [2] then connects smoothly to a cylindrical porous tube [3] with uniformly porous lateral walls, such as are commonly made for example with sintered metal powder. For convenience, this tube [3] with porous lateral walls will be referred to as the porous cylinder, or the porous cylindrical chamber, even though it is open on its left and right ends. This porous cylinder [3] is externally surrounded by an outer region containing the vapor/gas mixture generated by the condenser at controllable saturation ratio S. A sheath flow Q of this vapor/gas mixture [4] is driven by a pressure difference through the porous walls [3]. The aerosol (1) introduced from the left moves to the right through the interior of the porous cylindrical chamber. As the sheath gas [4] enters laterally and symmetrically through the porous walls [3], it pushes the boundary [5] separating the aerosol flow [1] from the entering sheath flow [4] more and more towards the center of the porous cylinder, but does so gradually and in a particularly stable form. In this way, the external flow of sheath gas surrounding symmetrically a much narrower central aerosol flow exits the porous cylindrical chamber through its right end, at which point the tube wall ceases to be porous becoming a relatively short thermally insulating tube [6]. The function of this insulator [6] is to enable maintaining the subsequent tube to the right [7] at a lower temperature than the saturator temperature at which the sheath gas [4], and the shrinking aerosol region [5] are maintained. The colder region [7] will be referred to as the condenser. Its function in CPCs using low diffusivity vapors is conventional, namely, to cause the gas exiting towards the left to achieve a saturation ratio S in excess of 100% near the axis of the condenser tube. An important stabilization mechanism of the new porous wall sheathing scheme is that the velocity of the gas moving horizontally within the porous cylinder increases linearly with the distance to the right. As the combined flow of aerosol and sheath reaches the right end of the porous cylinder, the velocity profile is radially smooth and monotonic, with zero axial velocity at the walls, and maximal velocity at the center. It is accordingly structurally comparable to the parabolic velocity profile achieved in fully developed laminar flow in a pipe. This initial velocity profile will evolve downstream in the cold region towards a parabolic flow. The velocity field created within the porous tube is considerably more stable than that created by a central injection needle, where the outer and inner capillary walls bring the flow velocity to zero. Note that the capillary injection flow presents a maximum velocity at the axis (the aerosol jet center), then a minimum between this jet and the sheath gas, at about the radial position of the outer diameter of the capillary. Moving further radially, a maximum of the velocity occurs somewhere within the anulus of sheath gas. Finally, the gas velocity drops to zero at the side wall. A further advantage of the porous wall sheathing scheme is that the axial acceleration of the flow limits the radial diffusive spreading of the aerosol particles by a mechanism analogous to that precluding the growth of the boundary layer in a stagnation point flow. The gas stream leaving the right end of the porous tube enters into a cylinder with impenetrable walls, having approximately the same inner diameter as the porous cylinder. The structure of the device downstream from this point is similar to that in conventional condensation particle counters (CPCs), with an insulator segment followed shortly after by the condenser. The insulator is introduced to decouple thermally the hot saturator walls from the cold condenser walls, such that each of these two parts has its own temperature.

The velocity field leaving the saturator and entering the condenser in this new sheathing approach offers several important advantages over the earlier capillary sheathing method. First, the gas flow will remain laminar under conditions comparable to those of the flow inside a smooth cylindrical tube, up to a Reynolds number of the order of 2000, and considerably more for a limited axial distance. This enables the use of relatively large sheath flows Q, with corresponding larger ratios Q/q and, therefore, higher resolving power. A second advantage is the greater ease of calculation of the velocity, temperature and vapor concentration fields required to determine Sₘₐₓ.

One should note that the use of porous cylindrical walls to sheath symmetrically an aerosol flow is not new. It has been used in aerosol focusing experiments by Barton Dahneke (private communication), and in focusing and impactor instruments by Rao et al. (1992, 1993). Their work, however involved low pressures and relatively low Reynolds numbers, whence flow stability was not an issue that required this approach. Porous tubes in prior studies have been used to achieve axisymmetry, which is naturally an important feature also in this invention. What is new is our use of this sheathing approach to widen the range of flow rates within which an outer and an inner gas stream can be stably joined stably. The approach has never been previously used in condensation instruments, and is in fact the first solution that becomes available to operate them at the relatively large flow rates of sheath gas needed to increase the resolving power. That the porous tube approach proposed is far from obvious is confirmed by the fact that the capillary sheathing approach has dominated the field for 40 years. All prior related devices have used the conventional capillary sheathing method. Those familiar with this field have been well aware of the stability problems associated to capillary sheathing, as shown by the visualization studies of McDermott et al. and of Stolzenburg and McMurry Although the existence of these stability limits has been known for decades, no means to overcome them have been previously found. As a reference, our measurements show that the resolving power of the instrument of Gallar et al. deteriorates visibly at a sheath gas flow rate Q=1 L/min with a tube diameter D=6.35 mm. Based on the room temperature kinematic viscosity of air v=0.15 cm²/s, this corresponds to a Reynolds number for the sheath gas flow Re=4Q/(πDv)=111. The resolution falls dramatically at Q=1.2 L/min, corresponding to Re=134. Our new sheathing configuration is not expected to exhibit any loss of stability even at Re-2000, at a flow rate almost 20 times larger than in prior art.

Another important additional advantage of the new sheathing method taught here is that the small aerosol flow may be initially colder than the vapor flow and contain no vapor. Yet, during its advance within the porous cylinder, the aerosol becomes effectively saturated with the vapor and reaches very much the same temperature as the sheath gas. Furthermore, this desirable uniformity of thermodynamic state is achieved with little diffusive broadening of the aerosol flow up to the right end of the sheathing porous tube [3]. Since the insulator [6] is relatively short, the aerosol has little time to diffuse radially as it enters into the cold region where is will soon grow into larger non-diffusing drops. This way the aerosol is confined into a narrow region of high saturation uniformity, with considerable benefit to the resolving power achievable.

We have described a cylindrical embodiment of the sheathing system. The cylinder may be replaced by a different axisymmetric shape such as a truncated cone. A planar embodiment is also included in this invention, where the porous tube depicted in FIG. 2 would be replaced by two approximately parallel surfaces perpendicular to the plane of the figure.

Improved saturation. One embodiment of the invention to achieve 100% saturation in the wet volume is shown in the view from the vertical seen in FIG. 3. The wet chamber is similar to the rectangular cuboid of Gallar et al. The gas enters through an entry tube [8] on the small side on the left, and progresses towards the opposite small side. In order to distribute uniformly the entry flow within the chamber, a baffle [9] is placed facing the jet of sample flow issuing from [8]. The baffle does not need to be solid, and may alternatively be a partially transparent screen. In order to increase vapor transfer to the gas, several thin porous vertical surfaces [10] are inserted in the pool. These surfaces [10] touch the liquid pool at their bottom, so the liquid rises by capillarity to their top. It is desirable that the various wetted surfaces do not touch each other and maintain a relatively uniform distance between them, as excessive local constrictions of the flow could aerosolize the liquid pool. 10 such parallel surfaces are shown in the schematic of FIG. 3. Using 9 plates we have achieved complete saturation of water vapor at Q_{w}=1.5 l/min. It is important that the plates do not occupy an excessive fraction of the chamber volume, as this would increase the flow velocity of the gas and decrease proportionally the saturation capacity. Note that the time required for the vapor to diffuse from one of this porous plates to the center of the space separating it from the neighboring plates is quadratic with their separation, so doubling the number of plates while making them half as thin would quadruple the saturation power of the device. It is therefore possible to saturate with water vapor a total flow rate substantially larger than the 1.5 l/min previously quoted. A vapor three times less diffusive than water, such as n-butanol, would be saturated at a flow rate of about 0.5 L/min. These numbers apply to the dimensions of the original wet chamber of Gallar et al. A chamber with a greater volume would naturally allow complete saturation at even higher flow rates.

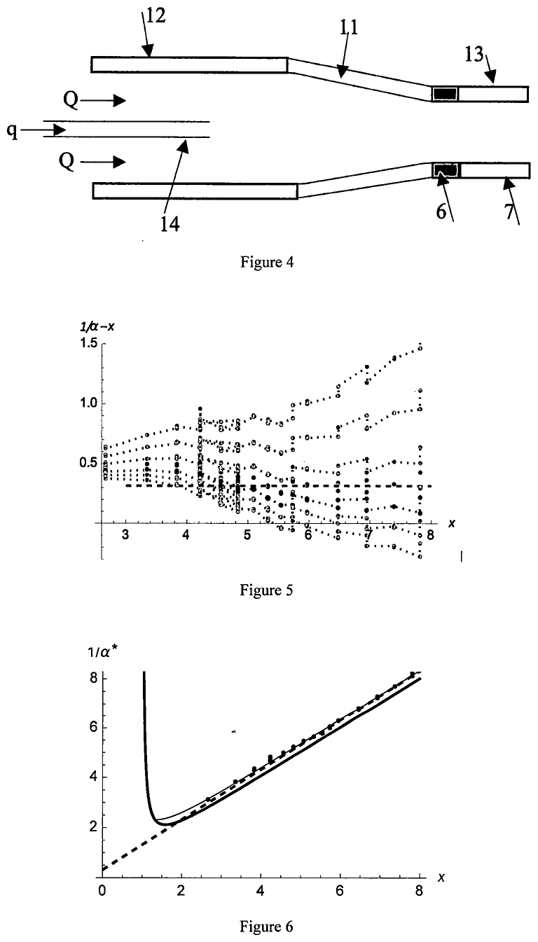

Flow stabilization by acceleration, This invention includes also alternative methods to achieve axisymmetric or planar laminar mixing at relatively high sheath gas flow rate, not requiring the use of porous walls. In one configuration relying on the familiar centered capillary with solid surrounding walls, the Reynolds numbers of the aerosol jet and of the sheath gas are reduced by simply widening the diameters of the capillary and the surrounding walls. At fixed flow rates, the respective Reynolds numbers are inversely proportional to the respective diameters. Once the two flows have met, the surrounding walls would converge into a smaller diameter. This is shown schematically by the convergent region [11] of FIG. 4, which follows a wider initial portion [12] of the saturator, and is followed by a narrower portion [13]. In this case, the centered capillary [14] is wider than in previous studies and ends before the beginning of the contraction. The capillary flow and the sheath flow are hence given some downstream space to settle before being accelerated in the converging region [11]. This way the sample flow and the sheath gas have a chance to accommodate their velocities to each other at moderately low Re before the acceleration. The subsequent acceleration naturally increases the Reynolds number, but in a region downstream from the unstable mixing region, where the flow is considerably more stable. In another embodiment of the invention (not shown in FIG. 4), the capillary [14] would extend into the beginning of the converging region, in which case the accelerating flow would stabilize the mixing of the two streams, delaying turbulent transition to Reynolds numbers considerably larger than in the case of mixing without flow acceleration. FIG. 4 shows the thermal insulator [6] separating the hot from the cold regions immediately after the end of the contraction. This early positioning of the insulator is not strictly necessary, though it reduces the path followed by the aerosol jet after the end of the capillary, therefore diminishing the broadening of the aerosol flow due to Brownian diffusion. From this viewpoint, the second configuration (not drawn) where the capillary extends into the beginning if the converging region is also advantageous.

A further improvement of the invention uses thin porous plates of metal. The interest of metal plates follows from their high thermal conductivity, since evaporative cooling may bring the plates to a temperature lower than the temperature of the saturator block, resulting in a gas stream saturated at a temperature below the saturator temperature, with a temperature gap that will depend on Q_{w}. A good heat conducting porous metal such as aluminum or bronze would minimize this undesirable temperature gap. Many other options to enhance heat transfer from the saturator chamber to the evaporating surfaces are available and are also included in this invention. In one of them the porous metal sheet is substituted by a metal plate sandwiched between two non-metallic porous surfaces. In this configuration the metal plate is effectively heated via a good thermal contact with the hot walls of the saturator, transmitting the heat efficiently to the wetted porous surfaces.

Still another embodiment of the invention includes a more efficient method to bring the dry portion of the sheath gas close to the temperature of the saturator. In the original design of Gallar et al. the dry chamber was empty, whence heat had to travel several cm from the chamber walls to its center. This limits the capacity to bring the dry gas to the chamber temperature, negatively affecting the desired linear response of the apparatus. In the present invention, heat transfer is enhanced by filling the dry chamber with aluminum wool, or some other good heat conductor in correct thermal contact with the walls of the saturator block. A finned heat transfer configuration with various metallic parallel plates, similarly as in the dry chamber, is also a practical alternative. The plates in this case do not need to be porous.

Water CPC. The VSCPS embodiment mainly described so far introduces a warm saturator stream into a cold surrounding. This approach is appropriate for vapors such as 2-butanol, whose diffusivity is less that the thermal diffusivity of the flowing gas. Certain aspects of the present invention do also apply to the reverse case, when the diffusivity of the working vapor exceeds the thermal diffusivity of the flowing gas. The work of S. V. Hering and colleagues on water CPCs has illustrated how to achieve a supersaturated state with highly diffusive water vapor (US20080083274A1). One suitable embodiment of our invention for highly diffusive vapors would still use the geometry of FIG. 2. In one configuration, hot gas carrying a variable humidity is injected inwards through the porous tube walls, such that the aerosol particles would on the one hand be concentrated at the center of the stream. One differences with the prior configuration for low diffusivity vapors, where the aerosol was hot is that the aerosol is now relatively cold. As the hot and humid gas enter through the porous tube, vapor and heat diffuse into the cold core, resulting in a relatively uniform saturation ratio in the center of the stream occupied by the particles. In this case, a more delicate balance of flows, temperatures and device length must be achieved, such that the point of maximal saturation arising in the vicinity of the axis is not reached substantially upstream of the point where the aerosol has already been confined maximally by the sheath flow into the core region of the tube. Note that the new porous tube configuration offers the additional advantage of minimizing the undesirable radial diffusion of the aerosol away from the center of the stream. Furthermore, the sheath gas could be almost pure steam near the boiling point of water, or a variable combination of steam and air (or another gas), in which case the configuration drawn in FIG. 2 would be a linear water-VSCPS. The use of water as condensing material has a number of well-known advantages described in prior work by Hering and colleagues. Other favorable features have been discussed in the last paragraph of Fernandez de la Mora (2020). One most relevant for the present invention is that the ratio Q/q required to achieve high resolution in a water CPC is substantially less than in other CPCs. This feature enables the use of a non-negligible flow rate q of cold aerosol, augmenting the operational flexibility of the water-VSCPS.

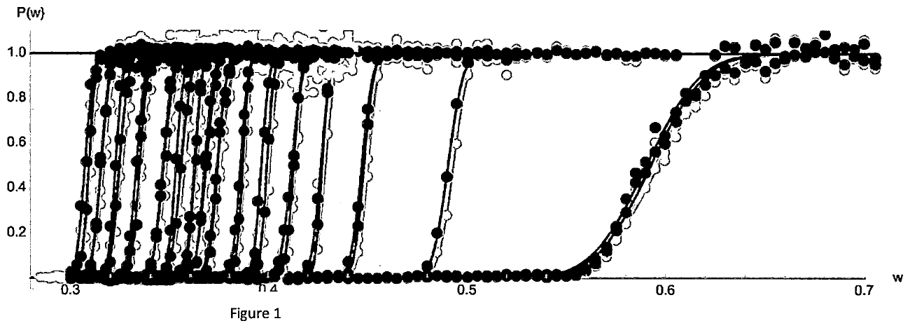

Experimental determination of the proportionality constant C. We have noted the linear relation (3) Sₘₐₓ=Cw. A method to determine the constant C is essential to determine Sₘₐₓ and from it a condensation size. Such a calibration method is accordingly included in this invention. The new method is strictly applicable to particles satisfying the requirements of the theory, namely, spherical particles of fixed composition that are wetted by the condensing fluid. For materials that are more complex in shape or chemical composition the method provides an equivalent size by comparison with reference particles. The basis of the method is that classical capillary theory should be applicable to the heterogeneous nucleation process for sufficiently large particles. By assuming a certain value of the constant C, one can convert data such as those in FIG. 1 (giving activation probabilities as a function of the experimentally measured wet fraction) from its original P(w) form into the theoretically interpretable form P(Sₘₐₓ). And by comparing such curves for various seed particle diameters with theoretical predictions one can choose C such as to obtain the best possible agreement between theory and measurements. A simple way of doing so is to focus on the mid points in FIG. 1 where P(w,dₚ)=½. These points give an experimental relation between w and dₚ. One then compares these experimental data in the form Cw(dₚ) with theoretical predictions Sₘₐₓ(dₚ), choosing C such the agreement is best. This process naturally depends on the nature of the capillary theory with which one makes the comparison. The process will be illustrated below for the case of capillary theory with finite activation energy and perfect wetting. The theory is originally due to Fletcher. Its concrete application to heterogeneous nucleation has been described by Fernandez de la Mora (2011), and we follow this approach here.

The critical condition that P=½ yields in this theory a complicated relation between the supersaturation variable a and the dimensionless particle diameter x. However this relation takes the following simple form in the limit when the particle diameter is relatively large compared with molecular dimensions:

$$\frac{1}{α ( x )} = \sqrt{c} + x + … , For relatively large x \qquad ( 3 )$$

For consistency with prior literature relation (3) is cast here in terms of dimensionless quantities:

$$x = \frac{{d}_{p}}{2 {L}_{i}} ; α = \frac{{kTL}_{i}}{2 γ {v}_{0}} ln S ; {L}_{i}^{3} = \frac{{q}^{2} ( 1 - 1 / ε )}{64 {π}^{2} {ε}_{0} γ} ; A = ln ( K τ / ln 2 ) ; c = AkT / ( 4 πγ {L}_{i}^{2} \qquad ( 4 - 8 )$$

where dₚ is the particle diameter, K is the preexponential rate constant appearing in Fletcher's expression for the rate of reduction of the number density N of particles being nucleated:

$$\frac{dN}{dt} = - KN exp [ \frac{- Δ G}{{k}_{B} T} ] ,$$

where ΔG is the energy barrier for nucleation given by capillary theory, k_{B} is Boltzmann's constant and T is the absolute temperature. τ is the residence time of the particles in the region where the maximal saturation ratio is achieved. The saturation ratio variable a, defined in (5) as proportional to InS, is simply the inverse of the Kelvin radius d_{K} made dimensionless with the electrical characteristic length Lᵢ defined in (6). This means that equation (3) may be recast in simpler terms as

$${d}_{K} = {d}_{p} + 2 {L}_{i} {c}^{12} . \qquad ( 9 )$$

Equation (3) is valid for both charged and neutral particles. Its derivation in the latter case can be found preceding equation (20) of Fernandez de la Mora (2011). The interesting point is that the particle diameter does not agree with the Kelvin diameter (as often assumed), but is displaced from it by the constant value Lᵢc¹². This displacement is independent of size, and therefore applies as well to large particles.

The estimated temperature at which the maximal a is achieved in the experiments of FIG. 1 is T*=22° C. For n-butanol, this results in the following numerical values for the key quantities governing the problem:

$$2 {L}_{i} = 1.128 nm ; {k}_{B} T / ( 4 πγ {L}_{i}^{2} ) = 0.0423 ; {k}_{B} {TL}_{i} ( 2 γ {v}_{0} ) = 0.3115 , \qquad ( 10 - 12 )$$

$$A = c s ; s = 4 πγ {L}_{i}^{2} / ( {k}_{B} T ) = 23.8 . \qquad ( 13 - 14 )$$

Note that the displacement √c in equation (3) fixes the kinetic parameter c, and therefore the unknown rate coefficient K. K may naturally depend on the nature of the vapor and the particle. In order to determine both c and the proportionality factor C, rather than plotting α⁻¹ versus x seeking a unit slope and a certain vertical displacement, FIG. 5 represents 1/α−x versus x for several assumed values of C. The correct choice for C is the one bringing the large x data along a horizontal line. One can see at large x in FIG. 5 that the slope changes from positive to negative, vanishing at about lnC=1.57 (data points not joined by dotted lines). FIG. 5 provides not only the correct value for lnC. In addition, the vertical displacement of the large particle data above the horizontal axis (dashed line) yields c^{1/2}=0.316. This also gives the quantity A in equation (7), and the associated quantity K_{τ}=7.49 in (15).

Having now all the quantities needed to compare critical activation measurements with theory, we represent critical values of α⁻¹ versus dimensionless particle diameter in FIG. 6. The thick line is Thomson's theoretical asymptote α=x⁻¹−x⁻⁴, corresponding to zero activation energy, as well as to the condition c=0. The thin continuous line is the full prediction from capillary theory, not restricted by the condition that x be large, used here for the calibration of C. The dashed line is the large particle asymptote x+c^{1/2}. It is clear in this representation that the Thomson (or Kelvin) asymptote is never reached. Since the Kelvin and the Thomson zero-activation-energy asymptotes coincide at large sizes, the Kelvin asymptote would not be reached either, even for particles much larger than 9 nm. On the other hand, the predicted asymptote with unit slope and a constant vertical displacement is achieved closely.

1. A sheathed condensation particle counter (CPC) capable of operating at unusually high flow rates of a sheathing gas by relying on flow stabilization means, keeping said flow laminar at a Reynolds number in excess of 140 in the region where said sheathing gas meets an aerosol flow.

2. The sheathed CPC of claim 1 where said stabilization is achieved by introducing said aerosol flow within an inner region, where it is progressively surrounded by said sheathing gas flow, initially separated from said inner region by a porous wall.

3. The sheathed CPC of claim 1 where said stabilization is achieved by accelerating said sheathing gas, either in a region surrounding a centered capillary bringing in said aerosol flow, or upstream of said region.

4. A sheathed CPC operated as a linear variable saturation condensation particle sizer (LVSCPS), where a vapor from a liquid contained in a wet volume kept at a saturation temperature Tₛ is carried by a gas flowing through said wet volume, such that said gas exiting said wet volume is close to 100% saturated with said vapor at said saturation temperature, and such that said close 100% saturation is maintained up to a maximal flow rate independently of the flow rate of said gas flowing through said wet volume, even when said maximal flow rate exceeds 0.1 l/min.

5. The sheathed CPC of claim 4, where said near 100% saturation is achieved in a wet volume containing several closely spaced plates effectively wetted by said liquid, said plates being arranged such that said gas advancing through said wet volume flows close to said several plates to achieve said saturation.

6. The sheathed CPC of claim 5, where said plates include thermally conducting elements enhancing heat conduction from the walls of said wet volume to said plates, such as to minimize evaporative cooling of said plates.

7. The sheathed CPC of claim 2 operated as a LVSCPS according to claim 4.

8. A method to infer particle diameter in the LVSCPS of claim 4 involving the following steps:
(a) introducing into said LVSCPC particles having one or several sizes characterized by one or several size parameters dᵢ.
(b) Operating said LVSCPC with a selected setting of temperatures and flow rates, to determine a wet fractions wᵢ at which each of said particles with said sizes dᵢ is detected with a predetermined efficiency. (c) Comparing a theoretical prediction with an experimental relation obtained between said w; values and said dᵢ values to infer a proportionality constant relating a maximal saturation ratio achieved inside said LVSCPS and a controllable wet fraction w within said CPC.

9. The sheathed CPC of claim 2 using a highly diffusive vapor, such as water, where said aerosol flow is relatively cold, and said sheathing gas is relatively hot and carries vapors of said highly diffusive vapor.

10. The sheathed CPC of claim 9 operated as a linear VSCPS according to claim 4
